(19) United States
(12) Patent Application Publication
(10) Pub. No.: US 2022/0204327 A1
(43) Pub. Date: Jun. 30, 2022

(54) TELESCOPIC FORK MECHANISM AND AUTOMATIC HANDLING EQUIPMENT

(71) Applicant: HANGZHOU EIOROBOT TECHNOLOGY CO., LTD., Zhejiang (CN)

(72) Inventor: Shuang SUN, Zhejiang (CN)

(73) Assignee: HANGZHOU EIOROBOT TECHNOLOGY CO., LTD., Zhejiang (CN)

(21) Appl. No.: 17/610,444

(22) PCT Filed: May 8, 2020
(86) PCT No.: PCT/CN2020/089082

§ 371 Date: Nov. 11, 2021

(30) Foreign Application Priority Data
Sep. 11, 2019 (CN) 201921517416.5

(51) Int. Cl. B66F 9/075; B66F 9/12

(52) U.S. Cl. CPC B66F 9/07513; B66F 9/122

(57) ABSTRACT

The invention relates to a telescopic fork mechanism and automatic handling equipment. The telescopic fork mechanism includes a body structure and fork arm structures slidably mounted on the body structure. The body structure includes a main body, and slide rail structures slidably mounted on the main body. The fork arm structures include at least two fork arm bodies slidably connected side by side on the slide rail structures and a powered caster structure mounted on a bottom side of a rear end of each fork arm body and used to drive each fork arm body to stretch and retract along the slide rail structure. The powered caster structures on all the fork arm bodies are independent from each other.

### TECHNICAL FIELD

The invention relates to the technical field of automation equipment, in particular to a telescopic fork mechanism and automatic handling equipment.

### DESCRIPTION OF RELATED ART

As a kind of automation equipment, the telescopic fork mechanism is often installed on automatic handling equipment such as forklifts, traveling bogies, etc. for picking up, placing and storing goods. At present, the telescopic fork mechanisms on the market mostly use a passive telescopic mode; that is, the stretching and retracting of the fork arm structure are achieved relying on the power provided by the mechanism mounted on the body, and the fork arm structure cannot completely stretch outside the body; in addition, the fork arm structure mostly uses a cantilever structure, which has poor load capacity; moreover, the two fork arm bodies of the fork arm structure are often connected as a whole, can only be stretched or retracted at the same time, and cannot be controlled separately.

### SUMMARY

Based on this, the invention provides a telescopic fork mechanism and automatic handling equipment, which has good load capacity, and can not only make the fork arm structure fully stretch out of the body, but also carry out separate telescopic control of each fork arm body of the fork arm structure.

In order to achieve the above objective, the invention proposes the following technical scheme.

The telescopic fork mechanism includes a body structure and fork arm structures slidably mounted on the body structure. The body structure includes a main body, and slide rail structures slidably mounted on the main body. The fork arm structures include at least two fork arm bodies slidably connected side by side on the slide rail structures and a powered caster structure mounted on a bottom side of a rear end of each fork arm body and used to drive each fork arm body to stretch and retract along the slide rail structure. The powered caster structures on all the fork arm body are independent from each other.

Alternatively, each powered caster structure includes a drive motor structure mounted on the fork arm body, and a driving wheel body connected to the drive motor structure. The drive motor structures of all the powered caster structure are independent from each other.

Alternatively, each fork arm structure includes the powered caster structure mounted on the bottom side of the rear end of the fork arm body. Or, each fork arm structure includes two powered caster structures mounted side by side on the bottom side of the rear end of the fork arm body;

Alternatively, the fork arm structures further include at least a retractable driven wheel structure mounted on a bottom side of a middle portion of each fork arm body.

Alternatively, the fork arm structures further include at least a retractable powered caster structure mounted on the bottom side of a middle portion of each fork arm body.

Alternatively, the slide rail structures include at least two slide rail bodies slidably mounted side by side on the main body, and each fork arm body is slidably mounted on a corresponding one of the slide rail bodies.

Alternatively, a rear end of the main body is provided with a first slide rail limiting structure, a front end of each fork arm body is provided with a second slide rail limiting structure, a front end of each slide rail body is provided with a body limiting structure corresponding to the first slide rail limiting structure, and a rear end of each slide rail body is provided with a fork arm limiting structure corresponding to the second slide rail limiting structure.

Alternatively, the main body is provided with two sliding grooves side by side, one of the slide rail bodies is slidably mounted in each of the two sliding grooves, and a corresponding one of the fork arm bodies is slidably mounted on each slide rail body.

Alternatively, each sliding groove includes a main groove body located in a middle portion of the main body, and an outlet groove body located at a rear end of the main body and communicated with the main groove body, and a bottom side and a rear side of the outlet groove body are communicated with the outside. When the fork arm structures are in a fully retracted state, the powered caster structure on a bottom side of a rear end of each fork arm structure is located in the outlet groove body and is in contact with the ground.

In addition, the invention further provides an automatic handling equipment, which includes the telescopic fork mechanism as described above.

In the technical scheme proposed by the invention, the powered caster structure mounted on the outer bottom portion of each fork arm body of the fork arm structure can drive the corresponding fork arm body to stretch or retract. In addition, by mounting the powered caster structure on each fork arm body, the stretching distance of each fork arm body is not limited by the size of the body structure, and each fork arm body can be stretched out of the body structure. Moreover, by mounting the powered caster structure at the rear end of each fork arm body, and mounting the front end of each fork arm body on the slide rail structure, the fork arm body can be supported from both ends, thereby greatly increasing the load capacity of the fork arm bodies and fork arm structures. Furthermore, the powered caster structures mounted on each fork arm body are independent from each other, so that each fork arm body can be independently controlled via the corresponding powered caster structure, and can independently perform telescopic movement according to requirements.

### BRIEF DESCRIPTION OF THE DRAWINGS

In order to explain the embodiments of the invention or the technical scheme in the prior art more clearly, the drawings to be used in the description of the embodiments or the prior art will be briefly introduced below. Obviously, the drawings in the following description are only some embodiments of the invention. For a person of ordinary skill in the art, other drawings can be obtained from the structures shown in these drawings without creative work.

FIG. 1 is a three-dimensional schematic diagram of a telescopic fork mechanism according to an embodiment of the invention;

FIG. 2 is a sectional schematic diagram of the telescopic fork mechanism (when fork arm structures are in a fully retracted state) according to the embodiment of the invention;

FIG. 3 is a sectional schematic diagram of the telescopic fork mechanism (when fork arm structures are in a partially stretched state) according to the embodiment of the invention; and

FIG. 4 is a sectional schematic diagram of the telescopic fork mechanism (when the fork arm structure is in a fully stretched state) according to the embodiment of the invention.

### DESCRIPTION OF THE TAG NUMBERS IN THE DRAWINGS

| Reference | | Reference | |
|---|---|---|---|
| number | Name | number | Name |
| 100 | Body structure | 110 | Main body |
| 112 | Sliding groove | 120 | Slide rail structure |
| 122 | Slide rail body | 200 | Fork arm structure |
| 210 | Fork arm body | 220 | Powered caster structure |

The realization of the purpose, functional characteristics and advantages of the invention will be further described in conjunction with the embodiments and with reference to the drawings.

### DESCRIPTION OF THE EMBODIMENTS

The technical schemes in the embodiments of the invention will be clearly and completely described below in conjunction with the drawings in the embodiments of the invention. Obviously, the described embodiments are only a part of the embodiments of the invention, rather than all the embodiments. All other embodiments obtained by a person of ordinary skill in the art based on the embodiments of the invention without creative work fall within the protection scope of the invention.

It should be noted that if there is a directional indication (such as up, down, left, right, front, back, top, bottom . . . ) involved in the embodiment of the invention, the directional indication is only used to explain the relative position relationship, movement, etc., between the components in a particular attitude (as shown in the drawings). If the particular attitude is changed, the directional indication changes accordingly.

In addition, if there is a description involving “first”, “second”, etc. in the embodiment of the invention, the description of “first”, “second”, etc. is used for a descriptive purpose only, and cannot be construed as indicating or implying its relative importance or implicitly specifying the number of technical features indicated. Thus, the feature qualified with “first” and “second” may explicitly or implicitly include at least one such feature. In addition, the technical schemes between the embodiments can be combined with each other, but only on the basis that the technical schemes can be achieved by a person of ordinary skill in the art. When the combination of technical schemes is contradictory or impossible, such combination of technical schemes shall be considered as not existing and not within the scope of protection claimed by the invention.

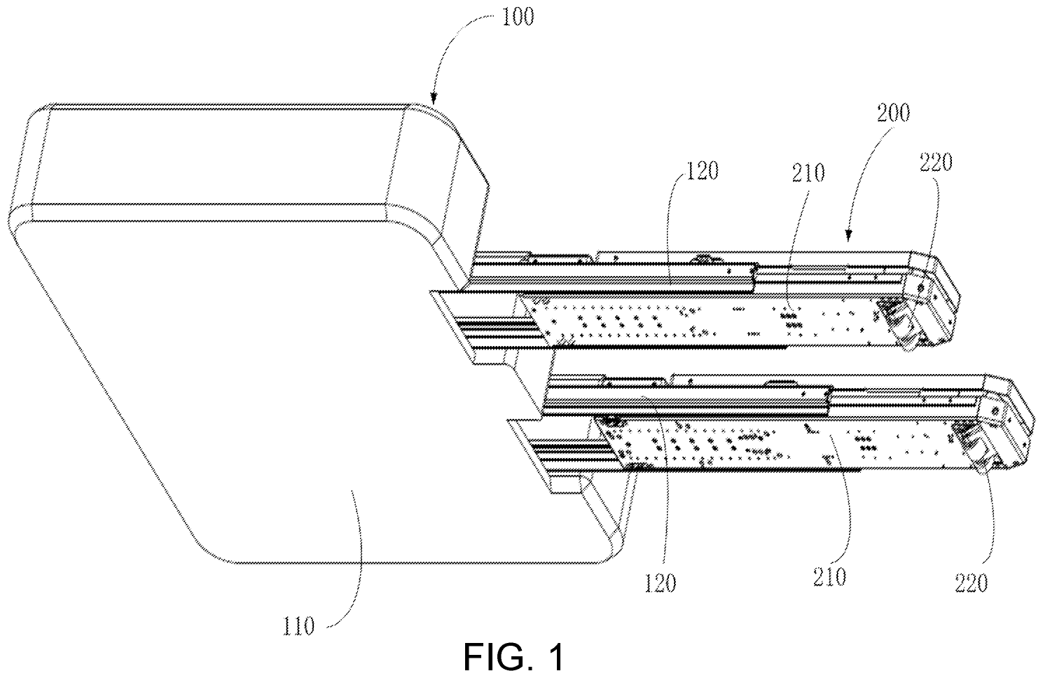

As shown in FIG. 1, the invention proposes a telescopic fork mechanism, including a body structure 100 and fork arm structures 200 slidably mounted on the body structure 100. The fork arm structures 200 can be slid into the body structure 100 or outside the body structure 100 so as to facilitate the forking and handling of an object via the fork arm structures 200. Moreover, each fork arm structure 200 can be self-driven by its own structure without need to additionally mount a power structure on the body structure 100, so that each fork arm structure 200 is stretched and retracted more freely and simply.

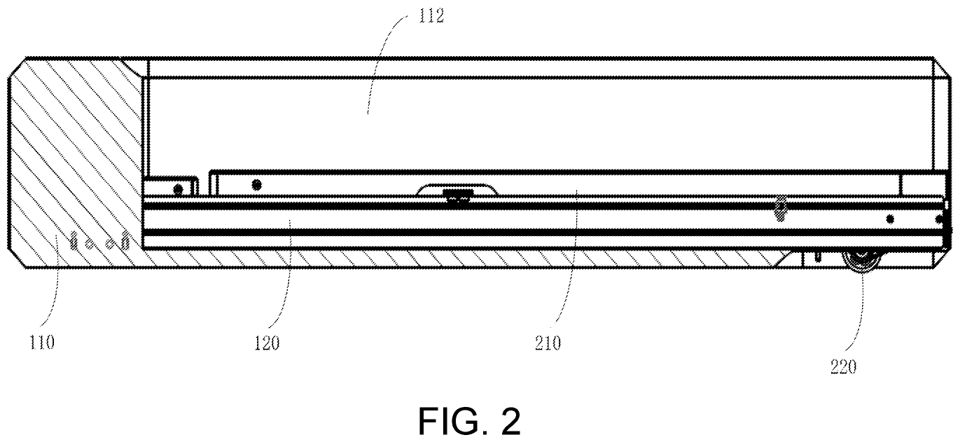

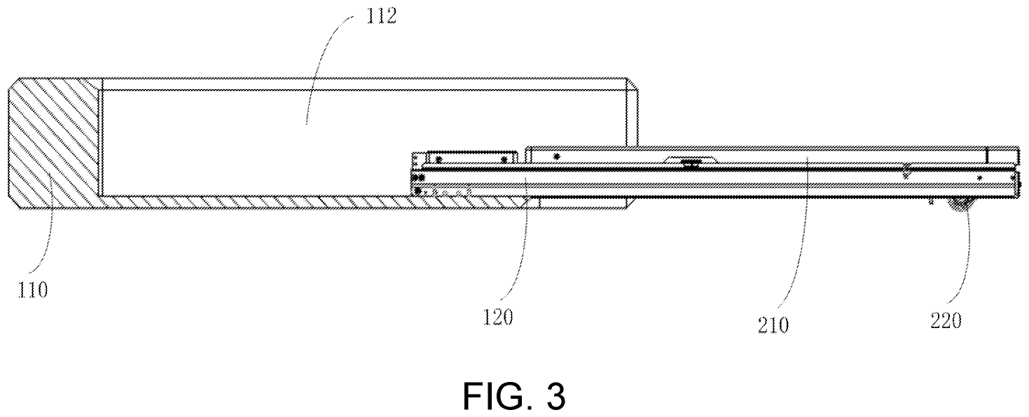

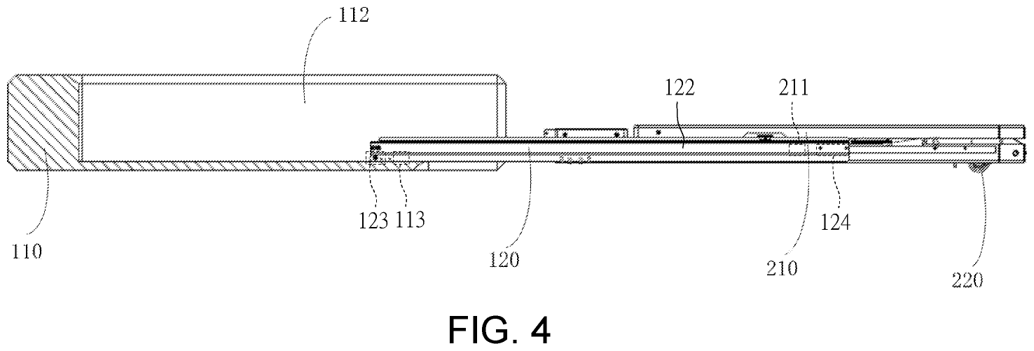

Specifically, as shown in FIG. 2 to FIG. 4, the body structure 100 can include a main body 110, and slide rail structures 120 slidably mounted on the main body 110. In addition, the fork arm structures 200 can include at least two fork arm bodies 210 respectively slidably connected side by side on the slide rail structures 120 and a powered caster structure 220 mounted on the bottom side of the rear end of each fork arm body 210 and used to drive the fork arm body 210 to stretch and retract along the slide rail structure. The powered caster structures 220 on all the fork arm bodies 210 are independent from each other. The powered caster structure 220 mounted on the outer bottom of the fork arm body 210 of the fork arm structure 200 can drive the corresponding fork arm body 210 to stretch out of the main body 110 or retract into the main body 110. Moreover, by mounting the powered caster structure 220 on each fork arm body 210, the stretching distance of the fork arm body 210 is not limited by the size of the body structure 100, and the fork arm body 210 can be stretched out of the body structure 100. In addition, by mounting the powered caster structure 220 at the rear end of each fork arm body 210, and mounting the front end of the fork arm body 210 on the slide rail structure 120, the fork arm body 210 can be supported from both ends, thereby greatly increasing the load capacity of the fork arm body 210 and fork arm structure 200. Furthermore, the powered caster structures 220 mounted on each fork arm body 210 are independent from each other, so that each fork arm body 210 can be independently controlled via the corresponding powered caster structure 220, and can independently perform telescopic movement according to requirements.

Further, the main body 110 can be provided with a receiving groove extending along the front-to-rear direction of the main body 110, and the rear end of the receiving groove penetrates the rear end of the main body 110. The slide rail structures 120 can be slidably mounted in the receiving groove, slide back and forth in the receiving groove, and stretch out of the main body 110 or retract into the main body 110.

Moreover, the receiving groove can include at least two sliding grooves 112 mounted side by side on the main body 110, and the rear end of each sliding groove 112 penetrates the rear end of the main body 110. Correspondingly, the slide rail structures 120 can include at least two slide rail bodies 122 slidably mounted side by side on the main body 110, each slide rail body 122 is slidably mounted in a corresponding sliding groove 112, and each fork arm body 210 is slidably mounted on a corresponding slide rail body 122. Thus, each fork arm body 210 can slide back and forth on a slide rail body 122, and each slide rail body 122 can slide back and forth in a sliding groove 112. In addition, at least two slide rail bodies 122 can also be slidably mounted in a sliding groove 112, or all slide rail bodies 122 are mounted in a sliding groove 112. Moreover, the receiving groove can also be set as a sliding groove 112.

Furthermore, in this embodiment, the main body 110 can be provided with two sliding grooves 112 side by side. A slide rail body 122 is slidably mounted in each of the two sliding grooves 112, and each slide rail body 122 is slidably provided with a corresponding fork arm body 210. That is, two sliding grooves 112 can be mounted on the main body 110, two slide rail bodies 122 are correspondingly mounted, and the two slide rail bodies 122 are in one-to-one correspondence with the two fork arm bodies 210. That is, the two fork arm bodies 210 can respectively slide along the two slide rail bodies 122, so that each fork arm body 210 can stretch out of the main body 110 or retract into the main body 110 through the corresponding slide rail body 122. Moreover, the powered caster structure 220 separately mounted on each fork arm body 210 can separately drive the two fork arm bodies 210 to stretch and retract, which can adapt to different forking scenarios and is convenient and simple. If only one fork arm body 210 is needed to fork and pick up an object, one fork arm body 210 can be only telescopically driven by a powered caster structure 220. If two fork arm bodies 210 are needed to fork and pick up an object, the two fork arm bodies 210 can be telescopically driven by two powered caster structures 220 respectively.

In addition, each sliding groove 112 can include a main groove body located in the middle portion of the main body 110, and an outlet groove body located at the rear end of the main body 110 and communicated with the main groove body, and both the bottom side and the rear side of the outlet groove body are communicated with the outside. Thus, both the bottom side and the rear side of the rear end of the sliding groove 112 are communicated with the outside, the bottom side of the rear end of the sliding groove 112 corresponds to the ground, and the rear side of the sliding groove 112 penetrates the rear end face of the main body 110. In this way, when the fork arm structure 200 is in a fully retracted state, the powered caster structure 220 on the bottom side of the rear end of the fork arm structure 200 can be located in the outlet groove body and contact the ground (this can not only contain the powered caster structure 220 through the outlet groove body, but also facilitate the landing of the powered caster structure 220 so as to drive the fork arm body 210), and it is convenient to push the fork arm body 210 of the fork arm structure 200 out of the sliding groove 112 through the powered caster structure 220 so as to stretch out of the rear end of the main body 110.

In addition, the rear end of the main body 110 can be provided with a first slide rail limiting structure, the front end of each fork arm body 210 can be provided with a second slide rail limiting structure, the front end of each slide rail body 122 can be provided with a body limiting structure corresponding to the first slide rail limiting structure, and the rear end can be provided with a fork arm limiting structure corresponding to the second slide rail limiting structure. Thus, when the front end of the slide rail body 122 is slid to the rear end of the main body 110 in the process of sliding the slide rail body 122 in the sliding groove 112 outwardly toward the rear end of the main body 110, the body limiting structure mounted at the front end of the slide rail body 122 can be clamped on the first slide rail limiting structure at the rear end of the main body 110, so that the slide rail body 122 will not be separated from the main body 110. Moreover, when the front end of the fork arm body 210 is slid to the rear end of the slide rail body 122 in the process of sliding the fork arm body 210 on the slide rail body 122, the, the fork arm limiting structure at the rear end of the slide rail body 122 can clamp the second slide rail limiting structure at the front end of the fork arm body 210, so that the fork arm body 210 will not be separated from the slide rail body 122.

Specifically, the first slide rail limiting structure may be a first ring-shaped limiting baffle mounted at the rear end of the main body 110, and the main body limiting structure may be set as a first circular limiting baffle at the front end of the slide rail body 122. The slide rail body 122 can penetrate through the first ring-shaped limiting baffle and extend to the outer side of the rear end of the main body 110, and the first circular limiting baffle of the slide rail body 122 can clamp the inner side of the first ring-shaped limiting baffle (that is, the front end direction of the main body). Similarly, the fork arm limiting structure may be set as a second ring-shaped limiting baffle at the rear end of the slide rail body 122, and the second slide rail limiting structure may be a second circular limiting baffle mounted at the front end of the fork arm body 210. The fork arm body 210 can penetrate through the second ring-shaped limiting baffle and extend to the outer side of the rear end of the fork arm body 210, and the second circular limiting baffle of the fork arm body 210 can be clamped on the inner side of the second ring-shaped limiting baffle (that is, the front end direction of the fork arm body).

In addition, each fork arm structure 200 can include a powered caster structure 220 mounted on the bottom side of the rear end of the fork arm body 210; alternatively, each fork arm structure 200 can include two powered caster structures 220 mounted side by side on the bottom side of the rear end of the fork arm body 210. That is, a powered caster structure 220 can be mounted at the rear end of the fork arm body 210 to drive the fork arm body, or two powered caster structures 220 can be mounted side by side to drive the fork arm body. In addition, more powered caster structures 220 can be mounted at the rear end of the fork arm body 210 to drive the fork arm body.

Moreover, each powered caster structure 220 can include a drive motor structure mounted on the fork arm body, and a driving wheel body connected to the drive motor structure. The drive motor structures of all the powered caster structures are independent from each other. The drive motor structure mounted on the fork arm body 210 can drive the driving wheel body to rotate, so that the fork arm body is driven to move back and forth, and the fork arm body stretches out of the main body or retracts into the main body. In addition, the drive motor structure of each powered caster structure is independent, and each driving wheel body can be driven separately, which is convenient for separately driving each fork arm body 210 to stretch and retract. Moreover, each drive motor structure can include a drive motor mounted on the bottom side of the fork arm body 210, and a reducer connected to the output shaft of the drive motor. The rotating shaft of the driving wheel body is connected to the output shaft of the reducer.

Furthermore, the fork arm structures 200 can further include at least a retractable driven wheel structure mounted on the bottom side of the middle portion of each fork arm body 210. By mounting the driven wheel structure in the middle portion of each fork arm body 210, the fork arm body 210 can be supported additionally and the load capacity of the fork arm structure 200 can be further increased. And by setting the driven wheel structure as a retractable structure, when the driven wheel structure stretches to the outer side of the main body 110 along with the fork arm body 210, the driven wheel structure can be released from the fork arm body 210 to contact the ground and support the fork arm body 210. When the driven wheel structure is about to retract into the main body 110 along with the fork arm body 210, the driven wheel structure can be retracted into the fork arm body 210 without affecting the stretching and retracting of the fork arm body 210.

Furthermore, the fork arm structure can further include at least a retractable powered caster structure mounted on the bottom side of the middle portion of each fork arm body. By mounting the powered caster structure in the middle portion of each fork arm body, the powered caster structure can be combined with the powered caster structure mounted at the rear end of each fork arm body to telescopically drive the fork arm body, which can obtain a stronger driving force and also play a role in auxiliary supporting. Moreover, setting these powered caster structures as retractable structures will not affect the stretching and retracting of the fork arm body.

Furthermore, the invention also proposes an automatic handling equipment, which includes the telescopic fork mechanism as described above. One or more fork arm bodies of the telescopic fork mechanism can be independently telescopically driven through the independently mounted powered caster structure, which can meet different use requirements and has better adaptability.

The above are only preferred embodiments of the invention, and do not limit the patent scope of the invention, as a result. All the equivalent structural transformations made by using the description of the invention and the content of the drawings under the invention concept or directly/indirectly applied in other related technical fields are included in the scope of patent protection of the invention.

1. A telescopic fork mechanism, comprising a body structure and fork arm structures slidably mounted on the body structure; wherein
the body structure comprises a main body, and slide rail structures slidably mounted on the main body; and
the fork arm structures comprise at least two fork arm bodies slidably connected side by side on the slide rail structures, and a powered caster structure mounted on a bottom side of a rear end of each fork arm body and configured to drive each fork arm body to stretch and retract along a respective one of the slide rail structures; and the powered caster structures on all the fork arm bodies are independent from each other.

2. The telescopic fork mechanism according to claim 1, wherein each powered caster structure comprises a drive motor structure mounted on the fork arm body, and a driving wheel body connected to the drive motor structure; and the drive motor structures of all the powered caster structures are independent from each other.

3. The telescopic fork mechanism according to claim 1, wherein each fork arm structure comprises the powered caster structure mounted on the bottom side of the rear end of the fork arm body;
alternatively, each fork arm structure comprises two powered caster structures mounted side by side on the bottom side of the rear end of the fork arm body.

4. The telescopic fork mechanism according to claim 1, wherein the fork arm structures further comprises at least a retractable driven wheel structure mounted on the bottom side of a middle portion of each fork arm body.

5. The telescopic fork mechanism according to claim 1, wherein the fork arm structure further comprises at least a retractable powered caster structure mounted on the bottom side of a middle portion of each fork arm body.

6. The telescopic fork mechanism according to claim 1, wherein the slide rail structures comprise at least two slide rail bodies slidably mounted side by side on the main body, and each fork arm body is slidably mounted on a corresponding one of the slide rail bodies.

7. The telescopic fork mechanism according to claim 6, wherein a rear end of the main body is provided with a first slide rail limiting structure, a front end of each fork arm body is provided with a second slide rail limiting structure, a front end of each slide rail body is provided with a body limiting structure corresponding to the first slide rail limiting structure, and a rear end of each slide rail body is provided with a fork arm limiting structure corresponding to the second slide rail limiting structure.

8. The telescopic fork mechanism according to claim 6, wherein the main body is provided with two sliding grooves side by side, one of the slide rail bodies is slidably mounted in each of the two sliding grooves, and a corresponding one of the fork arm bodies is slidably mounted on each slide rail body.

9. The telescopic fork mechanism according to claim 8, wherein each sliding groove comprises a main groove body located in a middle portion of the main body, and an outlet groove body located at a rear end of the main body and communicated with the main groove body, and a bottom side and a rear side of the outlet groove body are communicated with outside;
when the fork arm structures are in a fully retracted state, the powered caster structure on a bottom side of a rear end of each fork arm structure is located in the outlet groove body and is in contact with a ground.

10. An automatic handling equipment, characterized by comprising the telescopic fork mechanism according to claim 1.
